(19) United States
(12) Patent Application Publication
(10) Pub. No.: US 2022/0237714 A1
(43) Pub. Date: Jul. 28, 2022

(54) SYSTEMS AND METHODS FOR GENERATING DYNAMIC LISTING OF HOTELS BASED UPON USER SELECTED PARAMETERS

(71) Applicant: Gautam Mukherjee, Etobicoke (CA)

(72) Inventor: Gautam Mukherjee, Etobicoke (CA)

(21) Appl. No.: 17/709,144

(22) Filed: Mar. 30, 2022

Related U.S. Application Data
(63) Continuation-in-part of application No. 15/695,814, filed on Sep. 5, 2017.

(51) Int. Cl. G06Q 50/14; G06Q 30/06; G06Q 30/02

(52) U.S. Cl. CPC G06Q 50/14; G06Q 30/0629; G06Q 30/0282; G06Q 30/0627

(57) ABSTRACT

Disclosed is a method of reviewing and selecting hotels based upon graded parameters comprises storing hotel grades for each of a plurality of hotel parameters based upon reviews of past guest reviews; providing the plurality of hotel parameters to a client; receiving rankings of the client for the hotel parameter; ordering each ranked parameter from most important parameter to least important parameter; ordering hotels with the hotel grades for the most important parameter from highest graded hotel to lowest graded hotel; creating a list of hotels from highest graded hotel to lowest graded hotel; and, displaying the list of hotels to the client. If more than one of the hotels have the same hotel grade for the most important parameter, then the hotel with a higher rating for the next most important parameter is the higher graded hotel.

### CROSS-REFERENCE TO RELATED APPLICATIONS

This application claims benefit under 35 U.S.C. § 119(e) of U.S. application Ser. No. 15/695,814 filed Sep. 5, 2017, which is hereby incorporated by reference herein in its entirety.

### TECHNICAL FIELD

The present disclosure generally relates to networking systems, and more particularly, to a system and method for generating dynamic listing of hotels based upon user selected parameters.

### BACKGROUND OF THE INVENTION

The present invention is related to software allows clients seeking a hotel room to review and select hotels based upon graded parameters. Generally, when a client is looking for a hotel room, the client may find hotels that are given a single rating and the client must read each review to determine the reasons why that reviewer rated the hotel. For example, the reviewer may have given a positive review for the hotel's service. Alternatively, the reviewer may have provided a negative review for the hotel's location. As a result, the client must read through numerous reviews to determine whether that hotel would be satisfactory to the client's specific set of needs. The present invention solves these and other problems by providing a novel method and system for reviewing and selecting a hotel. For example, the client may be focused on hotels with good service. The present invention allows the client to choose the good service as the most important criterion and the resulting search will provide a list of hotels with the highest grades for providing good service to its past patrons. Then, the second most important selected criterion will come into play and grade the set retrieved on the search for “Good service,” according to the second most important criterion, and so on, for other selected criteria.

### BRIEF SUMMARY OF THE INVENTION

In one aspect of the disclosure, a computer implemented method for generating hotel ratings of queried hotels' availability, includes: receiving a user query for hotels in a user specified area; receiving two or more user specified hotel parameters; receiving a user specified ranking of importance for each user specified hotel parameter; retrieving from a database, a first list of hotels containing a score based on a first user specified parameter, wherein the first user specified parameter is of a highest ranked importance; attaching a highest weighting value to each of hotels in the first list of hotels; retrieving from the database, a second list of hotels containing another set of scores based on a second user specified parameter, wherein the second user specified parameter is of a second highest ranked importance; attaching a second highest weighting value to each of hotels in the second list of hotels; initially ranking the hotels in the first list and in the second list based on the highest weighting value and the second highest weighting value; identifying hotels in the first list of hotels that have a rating score below a threshold value for the second user specified parameter; deducting a first point value from the hotels in the first list of hotels that have a rating score below a threshold value for the second user specified parameter; adjusting the ranking for the hotels in the first list of hotels that have a rating score below the threshold value for the second user specified parameter based on the deducted first point value; and ranking hotels in the first and second lists based on the first user specified parameter and the second user specified parameter, wherein a list of the ranking is displayed to the user to include the adjustment for hotels in the first list with deducted first point values.

In another aspect, a computer program product for generating hotel ratings of queried hotels' availability is provided. The computer program product comprises one or more computer readable storage media, and program instructions collectively stored on the one or more computer readable storage media. The program instructions include: receiving a user query for hotels in a user specified area; receiving two or more user specified hotel parameters; receiving a user specified ranking of importance for each user specified hotel parameter; retrieving from a database, a first list of hotels based on a first user specified parameter, wherein the first user specified parameter is of a highest ranked importance; attaching a highest weighting value to each of hotels in the first list of hotels; retrieving from the database, a second list of hotels based on a second user specified parameter, wherein the second user specified parameter is of a second highest ranked importance; attaching a second highest weighting value to each of hotels in the second list of hotels; initially ranking the hotels in the first list and in the second list based on the highest weighting value and the second highest weighting value; identifying hotels in the first list of hotels that have a rating score below a threshold value for the second user specified parameter; deducting a first point value from the hotels in the first list of hotels that have a rating score below a threshold value for the second user specified parameter; adjusting the ranking for the hotels in the first list of hotels that have a rating score below the threshold value for the second user specified parameter based on the deducted first point value; and ranking hotels in the first and second lists based on the first user specified parameter and the second user specified parameter, wherein a list of the ranking is displayed to the user to include the adjustment for hotels in the first list with deducted first point values.

In another aspect, computer server for generating hotel ratings of queried hotels' availability is provided. The server includes a network connection; one or more computer readable storage media; a processor coupled to the network connection and coupled to the one or more computer readable storage media; and a computer program product comprising program instructions collectively stored on the one or more computer readable storage media. The program instructions include receiving a user query for hotels in a user specified area; receiving two or more user specified hotel parameters; receiving a user specified ranking of importance for each user specified hotel parameter; retrieving from a database, a first list of hotels based on a first user specified parameter, wherein the first user specified parameter is of a highest ranked importance; attaching a highest weighting value to each of hotels in the first list of hotels; retrieving from the database, a second list of hotels based on a second user specified parameter, wherein the second user specified parameter is of a second highest ranked importance; attaching a second highest weighting value to each of hotels in the second list of hotels; initially ranking the hotels in the first list and in the second list based on the highest weighting value and the second highest weighting value; identifying hotels in the first list of hotels that have a rating score below a threshold value for the second user specified parameter; deducting a first point value from the hotels in the first list of hotels that have a rating score below a threshold value for the second user specified parameter; adjusting the ranking for the hotels in the first list of hotels that have a rating score below the threshold value for the second user specified parameter based on the deducted first point value; and ranking hotels in the first and second lists based on the first user specified parameter and the second user specified parameter, wherein a list of the ranking is displayed to the user to include the adjustment for hotels in the first list with deducted first point values.

In another embodiment of the present invention, the method further comprises: displaying the hotel grades of each parameter for a client-selected hotel from the list of hotels; and, displaying hotel information for the client-selected hotel.

In yet another embodiment of the present invention, wherein the method further comprises: receiving booking information from the client.

In another embodiment of the present invention, the method further comprises: obtaining client-inputted hotel grades for the client-selected hotel; obtaining a client-inputted written review for the client-selected hotel; calculating updated hotel grades for the hotel parameters; and, storing the updated hotel grades for the hotel parameters.

In yet another embodiment of the present invention, each of the parameters are selected from the group consisting of room feature, convenience of location, value for money, hotel characteristic, hotel service, amenity, and combinations thereof.

In yet another embodiment of the present invention, the room feature is selected from the group consisting of nicely furnished rooms, well appointed bathrooms, views, cleanliness of rooms, kitchen, refrigerator, microwave, and combinations thereof. The convenience of location is selected from the group consisting of restaurants nearby, distance from center of town, distance to airport, near public transportation, neighborhood safety, distance from attractions, ambience of hotel, environmental setting of the hotel, and combinations thereof. The hotel characteristic is selected from the group consisting of good service, eco-friendly, family-friendly, business-friendly, couple-friendly, pet-friendly, amenities for the disabled, and combinations thereof. The hotel service is selected from the group consisting of automated check-in, loyalty programs, and combinations thereof. The amenity is selected from the group consisting of gym, same day laundry, business center, pool, sauna, jacuzzi, on-site restaurant, internet, parking, breakfast included, and combinations thereof.

In another embodiment of the present invention, the parameters are nicely furnished rooms, good service, restaurants nearby, distance from center of town, value for money, good sized rooms, automated check-in, gym, same day laundry, and business center.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 illustrates an embodiment of a process of reviewing and selection hotels based upon graded parameters.

FIG. 2 illustrates a computerized system of an embodiment of the present invention.

FIG. 3 is an example of a computing environment that can be utilized by embodiments of the present invention.

FIG. 4 illustrates an example of a computing system that can be configured to perform any of the processes of the present invention described herein.

FIGS. 5-7 illustrate screen shots of a graphical user interface for implementation of embodiments of the present invention.

FIGS. 8A-8C are a flowchart of a process for generating dynamic ratings for a hotel selection platform in accordance with embodiments of the subject technology.

### DETAILED DESCRIPTION OF THE INVENTION

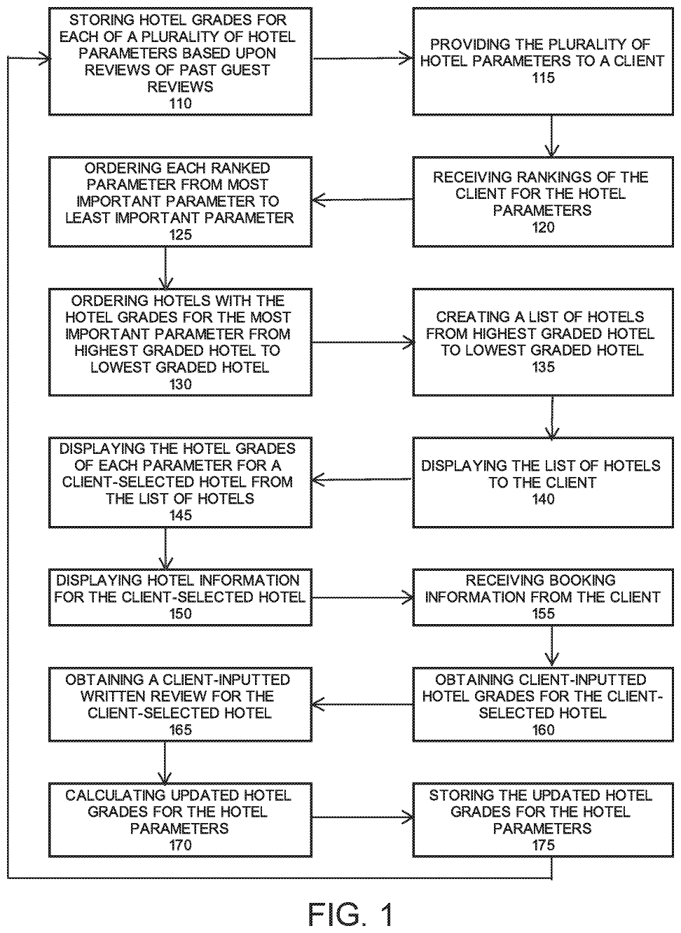

As illustrated in FIG. 1, an embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of reviewing and selecting hotels based upon graded parameters.

The method of reviewing and selecting hotels based upon graded parameters comprises storing hotel grades for each of a plurality of hotel parameters based upon reviews of past guest reviews 110; providing the plurality of hotel parameters to a client 115; receiving rankings of the client for the hotel parameters 120; ordering each ranked parameter from most important parameter to least important parameter 124; ordering hotels with the hotel grades for the most important parameter from highest graded hotel to lowest graded hotel 130; creating a list of hotels from highest graded hotel to lowest graded hotel 135; and, displaying the list of hotels and their scores for each parameter based on client preference to the client 140. If more than one of the hotels have the same hotel grade for the most important parameter, then the hotel with a higher rating for the next most important parameter is the higher graded hotel. For multiple parameters, scores for each parameter are collected, and calibrated for the next parameter score and this goes on until the last parameter score has been obtained and accounted for.

The method may further comprise: displaying the hotel grades of each parameter for a client-selected hotel from the list of hotels 145; and, displaying hotel information for the client-selected hotel 150. The hotel information may include the hotel's name, address, description, written reviews by past guests, ratings of each parameter, among other hotel information.

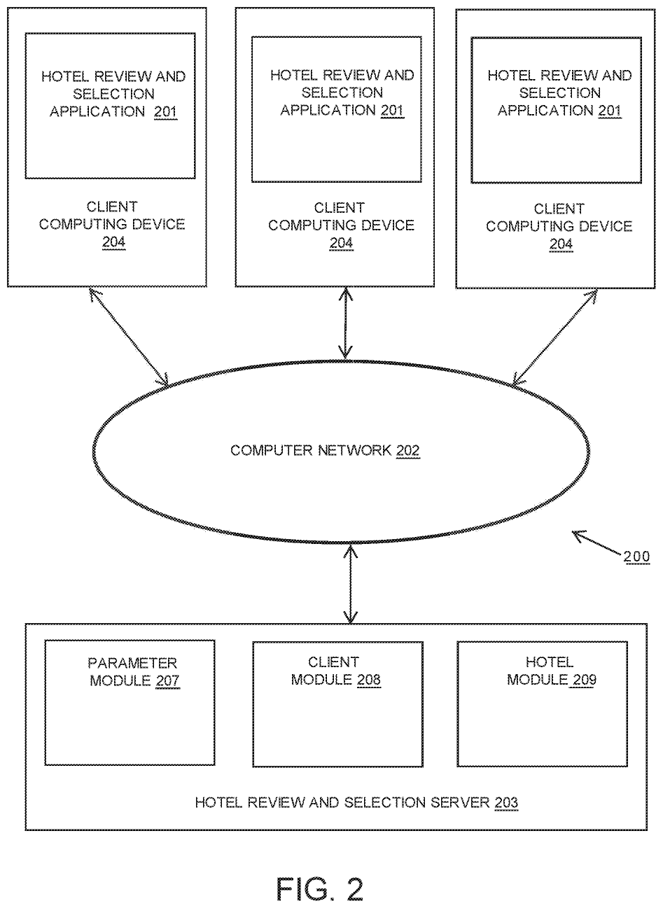

The method may further comprise: receiving booking information from the client 155. The booking information may include having the client register with hotel review and selection application 201 (see FIG. 2). The booking information may also include the client's name, screen name, email address, among other client information.

The method may further comprise: obtaining client-inputted hotel grades for the client-selected hotel 160; obtaining a client-inputted written review for the client-selected hotel 165; calculating updated hotel grades for the hotel parameters 170; and, storing the updated hotel grades and scores for each parameter for the hotel parameters 175. The client may optionally provide a written review of the hotel. By calculating 170 and storing the updated hotel grades for the hotel parameters 175, the hotel review and selection application 201 will have the current hotel parameter grades so the next client will have a better rating of the hotel.

Hotel parameters include room feature, convenience of location, value for money, hotel characteristic, hotel service, amenity, and combinations thereof. Value for money refers to reviewers' opinion about whether the hotel was worth the price they paid for the hotel.

Room features include parameters such as nicely furnished rooms, well appointed bathrooms, views, cleanliness of rooms, kitchen, refrigerator, microwave, and combinations thereof. Views may refer to whether the hotel affords pleasant scenery, such as a beach, ocean, lake, a landmark (e.g., the Eiffel Tower), among other scenic views.

Conveniences of location include parameters such as restaurants nearby, distance from center of town, distance to airport, near mass or public transportation, neighborhood safety, distance from attractions, ambience of hotel, environmental setting of the hotel, and combinations thereof. Attractions may include beaches, theaters, drug stores, convention centers, highways, golf, spa, and parks. The ambience of hotel may refer to the atmosphere of the hotel itself; for example, for those looking for a more romantic setting. The environmental setting of the hotel may refer to whether the hotel is located in a quiet, loud, congested, uncrowded, or busy location.

Hotel characteristics include parameters such as good service, eco-friendly, family-friendly, business-friendly, couple-friendly, pet-friendly, amenities for the disabled, and combinations thereof. Family-friendly hotel may offer optional cribs, recreation area, discounted kids' meals, and onsite babysitting. Amenities for the disabled include being wheelchair accessible, priority parking, automated door opening, mid-height light switches and power outlets, among other amenities.

Hotel services include parameters such as automated check-in, loyalty programs, and combinations thereof.

Amenities include parameters such as gym or Fitness Center, same day laundry, business center, pool, sauna, jacuzzi, on-site restaurant, internet, parking, breakfast included, and combinations thereof. Internet refers to any known internet service, including wireless internet services.

In another embodiment of the present invention, the parameters include nicely furnished rooms, good service, restaurants nearby, distance from center of town, value for money, good sized rooms, automated check-in, gym, same day laundry, and business center.

Another embodiment of the present invention is a non-transitory computer readable medium having computer readable instructions embodied therein, the computer readable instructions being configured to implement a method of reviewing and selecting hotels based upon graded parameters when executed. “Non-transitory computer readable medium” may not include a transitory signal.

FIG. 2 illustrates an embodiment of the present invention. Clients access the hotel review and selection application 201 with an enabled computing device 204. The enabled computing devices 204 may include such devices as tablet computers, smart phones, personal computers, laptop computers, scanners, game consoles and the like. The hotel review and selection application 201 may be software designed to help the clients review and select hotels based on various parameters. The hotel review and selection application 201 may also communicate with the hotel review and selection server 203 through the computer network 202. The computer network 202 may be, for example, the internet.

The hotel review and selection server 203 may contain various modules, including parameter module 207, the client module 208 and the hotel module 209. Each module 207, 208, 209 may store data. For example, the parameter module 207 may store the various parameters that clients may utilize to help the clients review and select hotels. The client module 208 may store information, details, and descriptions of the client's background (name, location, account number, login name, passwords, among other information), and other information. Also, the hotel module 209 may store the hotel's background (name, location, description, grades, among other information), and other information. The hotel review and selection server 203 may contain various other modules not shown, such as, a module that allows the client to post videos and photos related the client's stay at the hotel.

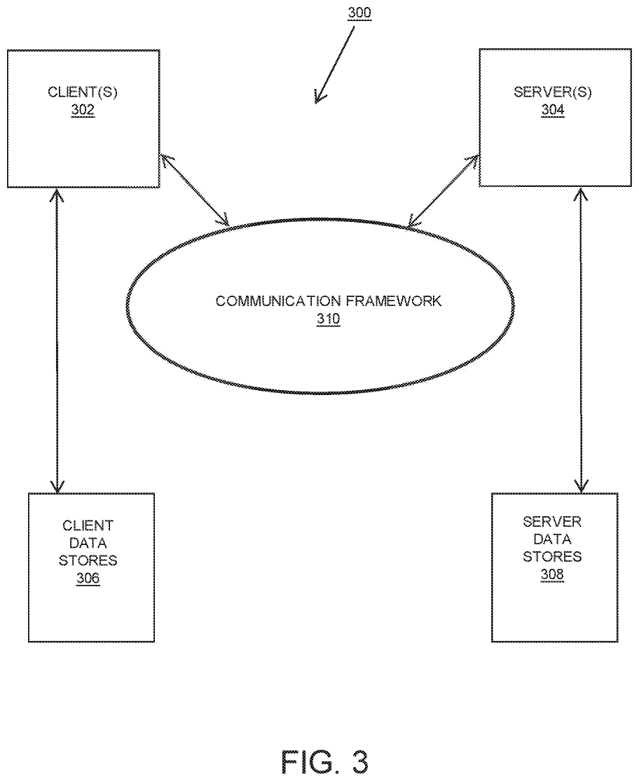

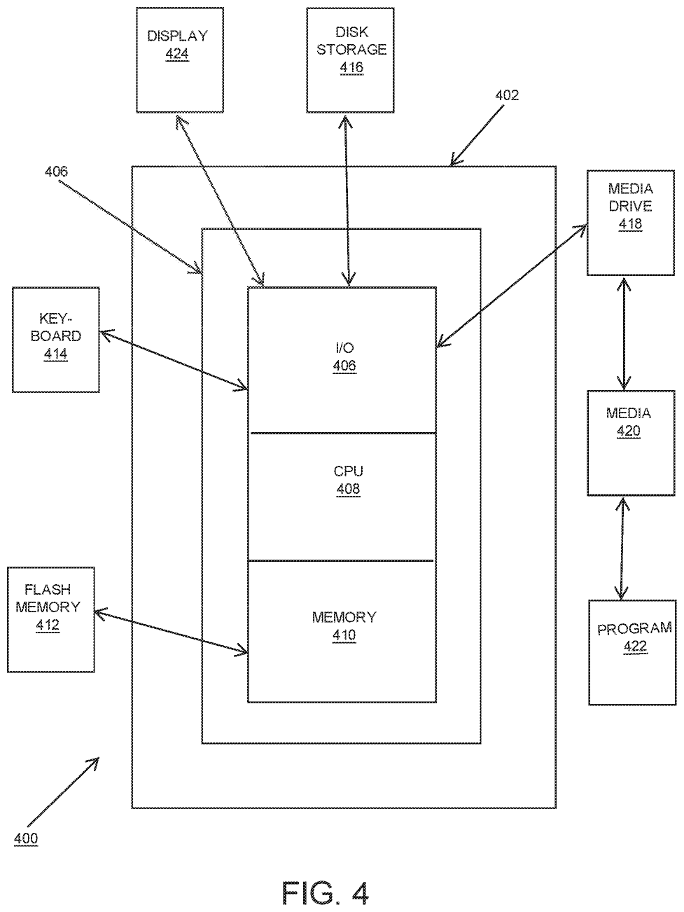

FIGS. 3 and 4 illustrate exemplary computing environments, devices and architectures for the implementation of the various embodiments of the present invention.

FIG. 3 illustrates a sample computing environment 300 that can be utilized in some embodiments. The system 300 further illustrates a system that includes one or more client(s) 302. The client(s) 302 can be hardware and/or software (e.g., threads, processes, computing devices). The system 300 also includes one or more server(s) 304, such as hotel review and selection server 203. The server(s) 304 can also be hardware and/or software (e.g., threads, processes, computing devices). One possible communication between a client 302 and a server 304 may be in the form of a data packet adapted to be transmitted between two or more computer processes. The system 400 includes a communication framework 310 that can be utilized to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304.

FIG. 4 depicts an exemplary computing system 400 that can be configured to perform any one of the above-described processes. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an I/O section 406, one or more central processing units (CPU) 408, and a memory section 410, which may have a flash memory card 412 related to it. The I/O section 406 is connected to a display 424, a keyboard 414, a disk storage unit 416, and a media drive unit 418. The media drive unit 418 can read/write a computer-readable medium 420, which can contain programs 422 and/or data. Although, not shown, in some embodiments, computing system 400 can include an eye-tracking system and/or be coupled with an eye-tracking system.

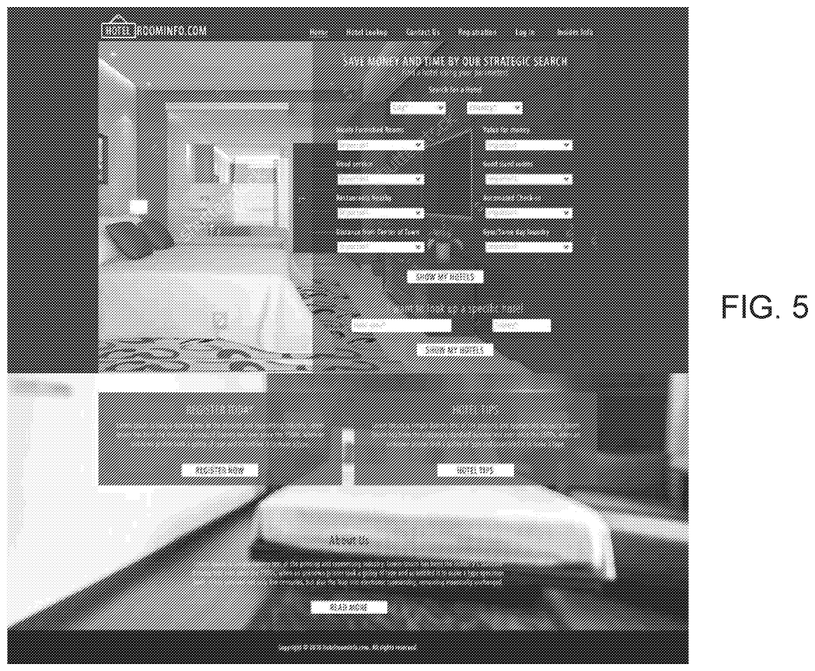

FIGS. 5-7 illustrate screen shots from a graphical user interface for implementations of some of the embodiments of the present invention.

FIG. 5 illustrates a representative example of a search page for client using the hotel review and selection application 201 with an enabled computing device 204. To begin, for example, the client would enter a location, such as city name and country, where the client is interested in finding a hotel. The client may select and rank several parameters; in this example, the parameters include “Nicely Furnished Rooms,” “Good service,” “Restaurants Nearby,” “Distance from Center of Town,” “Value for money,” “Good sized rooms,” Automated Check-in,” and “Gym/Same day laundry.” The client may select as many parameters as the client desires, preferably at least two, but the client may select only one. After choosing parameters in which the client is interested, the client then ranks the parameters from the most important to the least important. Then, the client receives a list of hotels based upon the highest graded/scored hotels for the client's most important parameter. If two hotels have the same grade/score for the client's most important parameter, then the hotel review and selection application 201 will utilize the next most important parameter (in other words, the parameter that the client ranked as the second most important parameter). The hotel with the higher grade for the second most important parameter would appear higher on the list of hotels resulting from the search. This may be repeated for the third, fourth, fifth, sixth, seventh and eighth most important parameters, if necessary.

As an example, the client may choose to look for a hotel in the city of Toronto in the country of Canada. The client then chooses and ranks the parameters of the client's interest in the following order: “Value for money,” “Restaurants Nearby,” and “Good service.” The ranking of the parameters may be numerically, in this example, as there are eight parameters, the client assigns an eight to the most important parameter (“Value for money”), a seven to the second most parameter (“Restaurants Nearby”), and a six to the third most important parameter (“Good service”). The hotel review and selection application 201 will generate a list of hotels based upon the client's chosen parameters and the grades based on reviews of prior guests. For example, there are four hotels (A, 8, C and D) that meet the client's criteria of being in Toronto, Canada. For “Value for money,” “Restaurants Nearby,” and “Good service”: Hotel A has grades of 7, 5, and 1, respectively; Hotel 8 has grades of 5, 6 and 2, respectively; Hotel C has grades of n/a, 7 and 3, respectively; and, Hotel D has grades of 7, 3 and 2, respectively. The hotels will be listed in the following order: Hotel A, Hotel D, Hotel 8, then Hotel C because Hotels A and D have the highest grade (7) for the client's most important parameter, “Value for money.” Because both these hotels have the same grade, then based upon the second most important parameter, “Restaurants Nearby,” Hotel A has higher grade (5) than Hotel D (3), Hotel A is listed ahead of Hotel D. Then, Hotel 8 is listed next because it has the next highest grade for the client's most important parameter, “Value for money.” Then, Hotel C is listed next because has the lowest grade (in this example, Hotel C has yet to receive a grade for this parameter) the client's most important parameter, “Value for money.” This example is representative and is not meant to be limiting, for example, the hotel review and selection application 201 may utilize more than eight parameters; the client may be interested in more than three parameters; the grades may be represented by other grading systems in that it may is not required to be numeric grades or that the grades are fractions and not whole numbers; and, the resulting list may have more or less than four hotels.

The client may want to suppress or exclude one or more parameters from the search. The client may do so by assigning zero to those parameters. The client may have an unlimited budget and may wish to stay in hotels of the finest refinement only. In such an instance, the client may rank the parameter “Value for money” as zero, so that lower priced hotels are not selected and only the other ranked parameters will be utilized by the hotel review and selection application 201 to determine the grades of the hotels.

Alternatively, the client may know the name of the hotel and location and input that information into the hotel review and selection application 201. Whether the client utilizes the choosing and ranking the parameters or entering the name and location of the hotel, the hotel review and selection application 201 will generate a list of hotels and display information related to the hotel. The information may include the hotel's name, description, location, contact information, grades for each parameter, among other hotel information.

The client may grade a hotel at which the client was a guest. The client may grade every parameter, or just those of interest to the client. The hotel review and selection application 201 will then use the client's grades to calculate and update the parameter grades for future clients of the hotel review and selection application 201.

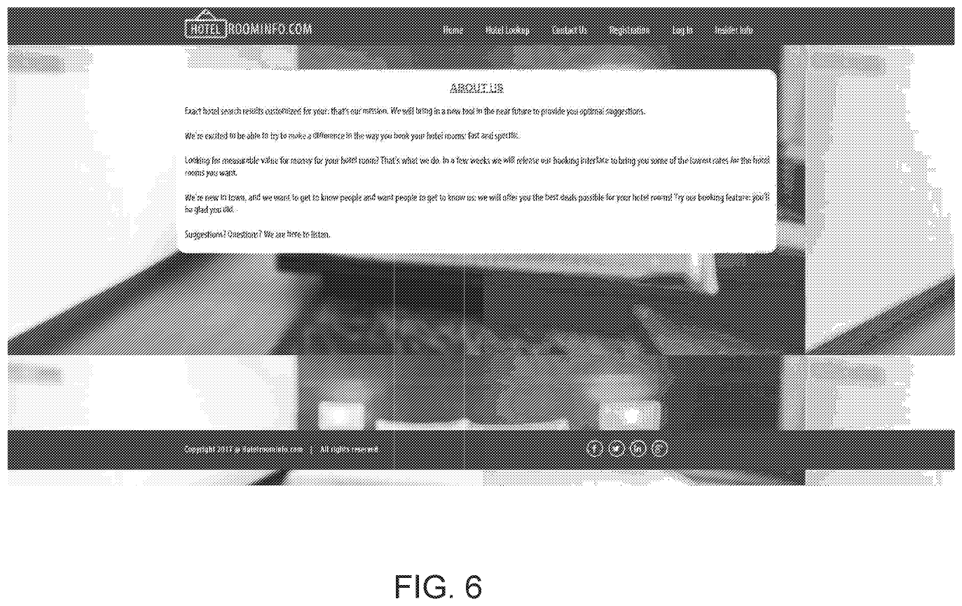

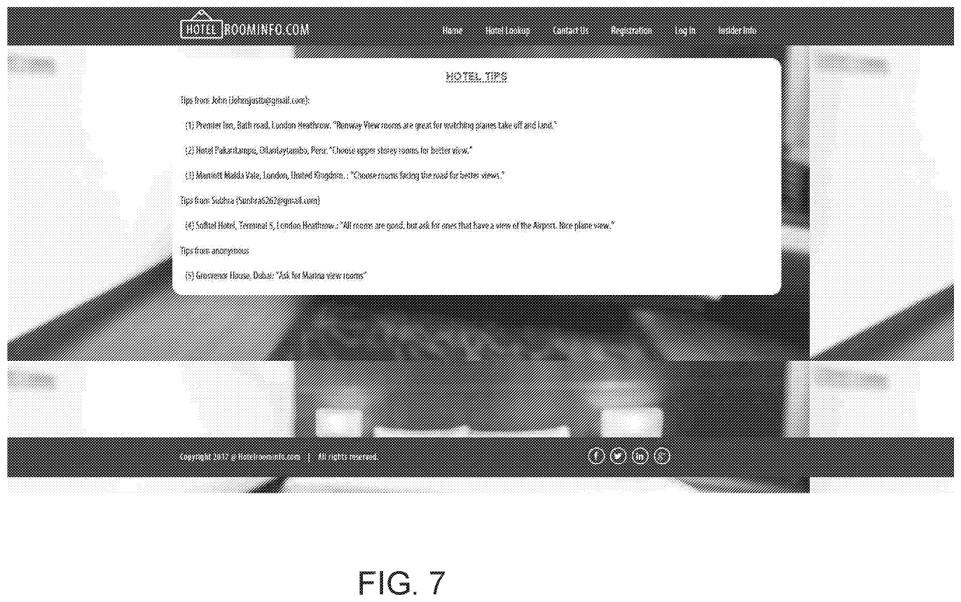

FIG. 6 illustrates a representative example of an “ABOUT US” page for client using the hotel review and selection application 201 with an enabled computing device 204. FIG. 7 illustrates a representative example of an “HOTEL TIPS” page for client using the hotel review and selection application 201 with an enabled computing device 204. These may include tips or advice from previous hotel guests.

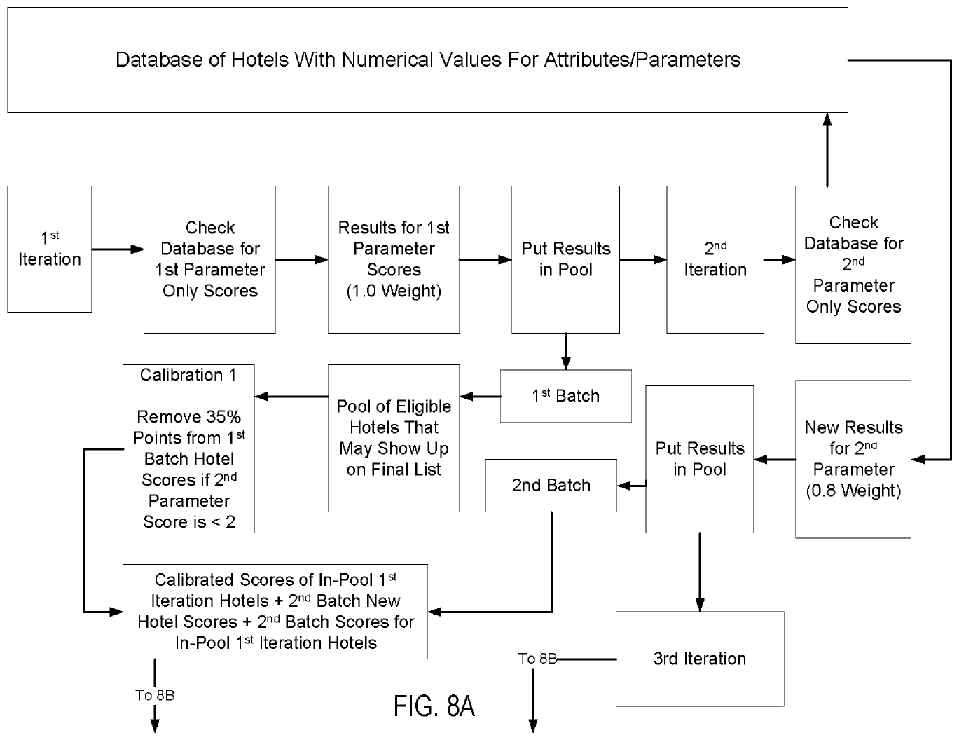

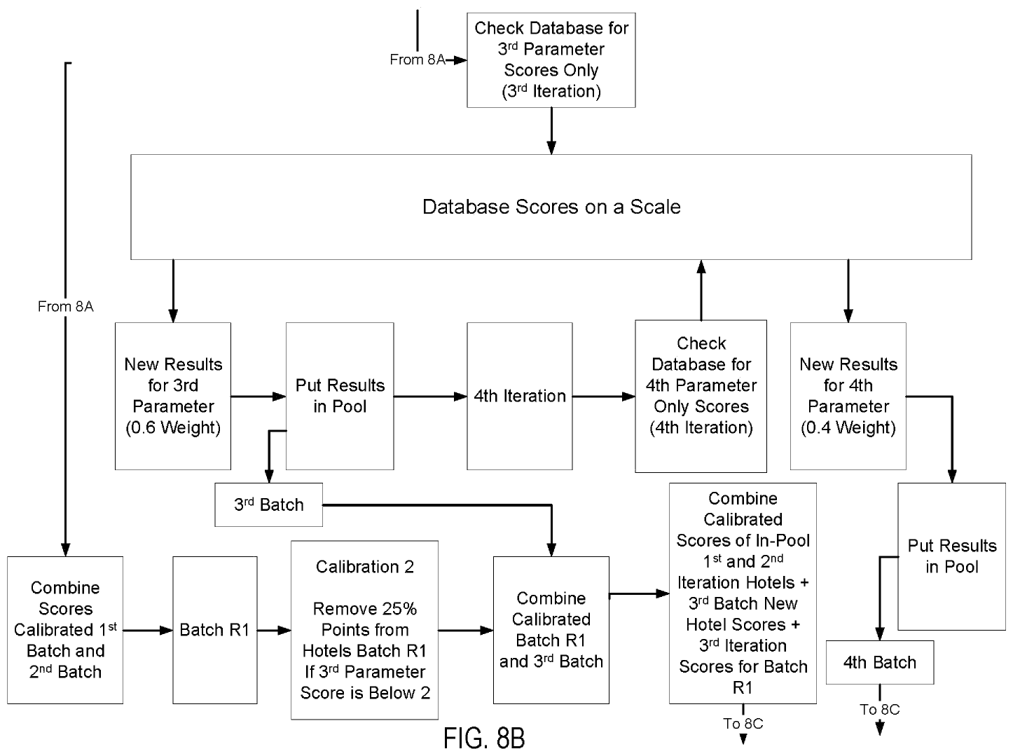

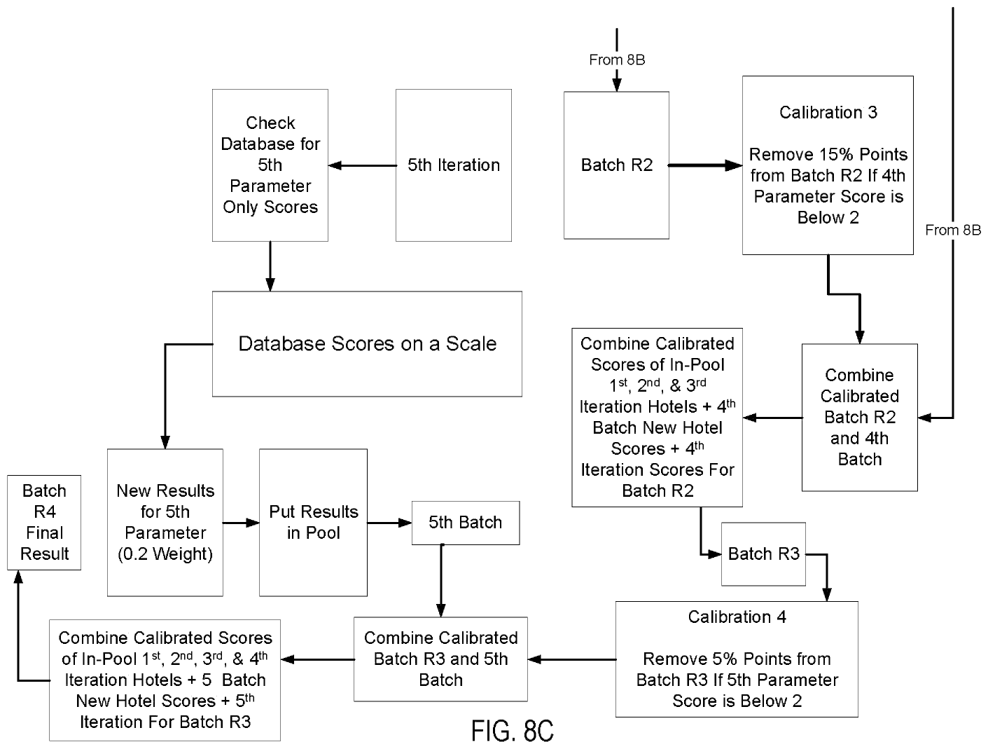

Referring now to FIGS. 8A-8C, a process for generating a dynamic rating based on multiple attributes is shown according to an illustrative embodiment. In one embodiment, the database contains scores for parameters related to hotels' ratings, provided by previous users. The attributes associated with a hotel's different ratings are considered in generating an overall score for each hotel based on the importance of user selected parameters. The user selected parameters are assigned a relative importance value. In an illustrative embodiment, the process considers some parameters more important than others in determining a ranking. Embodiments may refine the results in a separate operation so that one parameter being present does not result in the hotel getting a favorable rating overall, and conversely, the system checks that one parameter being absent does not result in a hotel being left out of the list of probable hotel choices. The algorithm rewards consistent high scores in all parameters rather than focusing on any one or two important parameters and ignoring the rest.

A “parameter” as used in this disclosure refers to user selected features or attributes associated with a hotel. For example, parameters may include the availability of one or more amenities, distance to an attraction, price, on-site restaurant quality, etc. In the process, a user may select one or more parameters of interest. In some embodiments, the user may specify which parameters have the most importance down to the least important before triggering a search query based on the user selected parameters. Aspects of the subject technology identify which hotels are likely the most relevant to a user's search query. The technology identifies candidate hotels and from among the candidate hotels, automatically assigns calculated rankings based on computer performed calculations that re-rank hotels as new criteria is accounted for. It will be appreciated that the following process is not practically performed by a person since a human or team of people could not reasonably or practically locate every hotel that has each parameter of the user's interest and then rank and re-rank the hotels for multiple parameters by pen and paper, in a reasonable amount. There are often hundreds of hotels available in some popular areas. Such a manual approach would require people to investigate each hotel and generate for any given area, calculate custom based results and reply with results to the searching user. There is no standard list to provide since each query is custom to the user's identified ranked parameters of importance. This type of manual process would likely require days for each query. By the time results for one query where returned, the results may be stale and unusable because the hotel room availability for each hotel has changed since the initial query.

In the subject process, there are two primary features in the ranking determination, which in some embodiments, may occur simultaneously: (1) Weightage and (2) Calibration. Hotels may be ranked by all around features, in which the most important parameter specified by a user carries a highest weight, and the parameter specified least important by the user carries the least weight, but all parameters may be factored in the calculations and rank. At different phases of the ranking determination process, a calibration step may occur which removes some of the value from one or more hotel candidates when one of the parameter scores is less than a threshold. The results displayed to the user will show hotels ranked based on weighting the criteria associated with each parameter and calibrating the rankings. Calibration may occur as each parameter is being factored into the current rankings. The hotels may be ranked initially based on the first parameter of highest importance. Thereafter, the rankings may be updated as additional parameters are factored in. In some embodiments, the calibration and re-ranking may occur with parameters factored in based on order of importance to the user.

In the illustrative process shown, hotels in the database may have files that include a rating score on a scale of 1-5 for each parameter available in the system. As will be seen in the calibration steps, when a score of 2 or less is found, an amount is removed from the batch of candidate hotels as the process further refines the rankings. It will be understood that the threshold value may vary among embodiments and the score of 2 is used for illustrative purposes only. Similarly, as will be seen, certain values have been used for the calibration steps. It will be understood that these values may vary from those shown here which are for illustrative purposes only. In addition, the illustrative flow is based on a user selecting five parameters, however it will be understood that embodiments may generally use three or more parameters to rank and calibrate the rankings for the final result.

A hotel that has a high rank on the most important parameter is very likely to be ranked high in the final result, depending on whether the same hotel also scores well in other parameters. If a hotel does not score well in other parameters, but is a “one hit wonder” that has one parameter ranking very well and others parameters rank high, the hotel will gradually fall off the ranked list with each iteration of the calibration steps during the process. In comparison, if a hotel does not score well on the most important parameter, but has other parameters scoring very well, it has a chance to make a high rank in the final list too: if all other parameters are very highly ranked and it has a good rank in the most important parameter. As may be appreciated, aspects of the process consider a broader picture of the various parameters important to a user rather than focusing on any not one parameter.

This system of rank determination starts with a database of all hotels, in which each hotel contains a numeric value for each parameter ranging from 1 to 5. These values for these parameters have been assigned for example, by previous users of the hotel. The system starts from this database and starts iterating two operations consecutively or concurrently: weightage and calibration.

The weightage function may be defined by the user. For example, the user defines which parameter is most important and the system assigns weightage accordingly.

The calibration operation may be performed automatically by the system with no other separate input by the user.

The process in FIGS. 8A-8C will be described in the following with the aid of an illustrative operation by a user.

In an illustrative embodiment, a user is shown a screen from which the user may select a plurality of parameters to be considered when ranking hotels. The user selects Distance from Center of city (DfC), Restaurants on site (RoS), Big Size Rooms (BsR), Strong Internet (SI) and Gym on Site (GoS) respectively as the 5 parameters. So, in one illustrative weighting system, DfC will have a rank multiplier of 1.0, RoS will have a rank multiplier of 0.8, BsR of 0.6, SI of 0.4 and Gos of 0.2.

The system already includes a database of hotels with individual values/scores from 1 to 5 (numerical value) in DfC, RoS and so on from reviews from past guests. This is NOT a combined rank list, but a dynamic list of hotels with values/scores of each parameter attached to it. These values are different, depending on the reviews.

In this example, in the first iteration, the system first goes through the database looking for hotels with the maximum score of the first parameter, (DfC). The system may retrieve all hotels with any DfC and multiplies their numerical value with rank multiplier of 1.0. The system does not necessarily rank the retrieved hotels for the first parameter yet. The system may place the retrieved hotels into a pool of “candidates” without any rank, but with the initial weighted value multiplied value attached. This is first weightage operation and the first set of hotels retrieved are labeled in the flow as “Batch 1”.

Second Iteration part 1: Now the system goes in the second iteration. The hotels in “Batch 1” have a score. Now, in the second iteration, all hotels (including those in “Batch 1”) may be considered for 2nd parameter scores but with a lower weightage value (for example 0.8). The system may multiply the second parameter value (RoS) of each hotel in the database by the weighting rank multiplier for the second parameter (for example, 0.8 based on the user's selection of this parameter as the second most important). This is the second weightage operation. That score is then added to the calibrated score of “Batch 1” hotels (ones that were obtained from the 1st iteration), which may include for example, hotels present in both the first and second iterations. So, a hotel that has parameter 1 and parameter 2, may receive varying scores twice till this point after the second iteration. If a hotel is not present in the 1st iteration list (say because the first parameter is absent in the hotel), but figures in the second iteration, then that hotel is added to the pool and its score is lower than those hotels who are on the list for both the first and second parameters. Hotels whose scoring is based only on parameter 2, will have received a score only once, until iteration 2, because these hotels do not have any contribution from 1st parameter scores. The results may be brought into the pool of results. The results of the second weightage operation are Batch 2.

There are already other hotels in the pool from the first iteration and the system (Batch 1). The system looks in the pool for the RoS factor of those Batch 1 hotels (already in the pool). If the Batch 1 hotels' RoS score is equal to or less than 2, the system deducts for example, 35% of points from those Batch 1 hotels. If their score in RoS is above 2, the system does not necessarily add or subtract any rating value. This is first calibration operation. Calibration is performed on the previous iteration/iterations results only; not generally on the results of the instant iteration. For example, in the first iteration, there is no calibration as since the data represents the first batch result, and there is no previous batch to calibrate. In second iteration, the scores of the hotels of the first batch will be calibrated (if their second parameter score is below, for example, 2). And then the scores from the second batch will be added to existing hotels. If a hotel did not figure in first batch, it may be used to compute the second batch for the first time, and will get added to calibrated scores and form R1. For sake of eliminating repetition, it will be understood that calibration under this method may occur after each iteration for a subsequent iteration.

Now the system combines in the pool those adjusted Batch 1 hotels (after first calibration) and new RoS, each with their respective scores. This is Batch R1. As may be appreciated, the process rewards an optimal mix of attributes, rather than, rank findings solely on one attribute and no other. After the first calibration, the numerical values of the rank in the pool may have changed from their rank in the first batch.

After this second iteration and second calibration operation, the numerical values of the hotels in the pool have changed from the first iteration. Hotels with top ranks in DfC got the higher numerical value in the first iteration, but after the second iteration, some of those hotels that are close to center, but have no restaurants on site may have a lower numerical value.

So, during the second iteration, the operations are: retrieving numerical values outside pool, multiplication by rank multiplier (weightage operation), retrieving previous numerical values in pool, deduction of a percentage if needed (first calibration operation), and assignment of cumulative updated batch of hotels in pool.

Third iteration part 1: The system multiplies the third parameter value (BsR) of each hotel in the database by the rank multiplier based on importance as designated by the user's selection. In an illustrative embodiment, the rank multiplier value for the third parameter is 0.6. And then, hotels weighted for the third parameter may be brought into the pool. This is third weightage operation. The hotels in batch R1 have a score. In the third iteration, all hotels in database (including those in the batch R1) may be considered for 3rd parameter scores with weightage of 0.6. That 3rd parameter score may then be added to the calibrated score of batch R1 hotels (ones that were obtained from the 1st and 2nd iterations). In some embodiments, the calculation for the 3^{rd} iteration may include hotels present in both first, second and third iterations (for example, for hotels receiving scores for parameters 1, 2 and 3). These hotels have received cumulative scores thrice at this point after the third iteration. So, a hotel that has scoring values for parameters 1, 2, and parameter 3, receives varying scores thrice until this point after the third iteration.

If a hotel is not present in the 1st and 2nd iteration lists (for example, because the 1^{st} and 2nd parameter attributes are absent in the hotel), but figures in 3rd iteration, then that hotel is added to the pool and its score is obviously lower than those hotels who have values in all 1st, 2nd and 3rd parameters and as compared to those that have only two of the three parameter values in their scoring. These hotels, which have a value only for parameter 3, have received a score only once, until iteration 3, because they do not have any 1st or 2nd parameter scores. Some hotels may also have only scores for two of the three parameters at this point. The result of the third weightage operation is Batch 3.

As before, there already are other hotels in the pool from the first and second iterations, that is Batch R1. If their BsR score is equal to or less than 2, the system may deduct for example, 25% of the points from those batch R1 hotels. This is a second calibration operation.

Now the system combines these adjusted Batch R1 results and batch 2, and combines them to become Batch R2.

Fourth Iteration: The system multiplies the fourth parameter value (SI) of each hotel in the database by the rank multiplier (derived from the user's selection) that is 0.4. The weighted results are added into the pool. This is fourth weightage operation. Similar to the 2^{nd} and 3^{rd} iteration, some hotels may be present in any one or more of the lists for the 1^{st}, 2^{nd}, 3^{rd}, and 4^{th} parameters. Depending on their cumulative scores for each iteration/batch a hotel is present in, their overall score may be re-ranked from the previous batch. Thus, some hotels that were previously ranked lower than other hotels after the 3^{rd} parameter was considered, may move ahead if a hotel has a value for the 4^{th} parameter and another does not have a value for the 4^{th} parameter. In some instances, even though a hotel may not have a value for the 4^{th} parameter, it may still outrank another hotel with a value for the 4^{th} parameter depending on previous scoring and weighting of higher weighted parameters. As will be appreciated, the ranking thus reflects a refined and balanced scoring based on which parameters are most important and which hotels offer more of the parameters a user shows interest in. For example, a hotel that has only the first and most prioritized parameter may not list as high as one that lacks the first parameter but has three or more of the other parameters. Such a situation may depend on the weighting values. Those hotels that only have a value for the fourth parameter will rank lowest in the overall list rank at this point. The result of the fourth weightage operation is Batch 4.

As before, there already are other hotels in the pool from the first, second and third iteration, that is Batch R2. If their SI score is equal to or less than 2, the system may deduct 15% points from those batch R2 hotels. This is third calibration operation.

Now the system combines these adjusted Batch R2 results and Batch 4, and combines them to become Batch R3.

Fifth Iteration: The system multiplies the fifth parameter value (GoS) of each hotel in the database by the rank multiplier (derived from the user's selection) that is 0.2. The weighted results are brought into the pool. This is fifth weightage operation. The process in the fifth iteration is similar to the fourth iteration except that a fifth parameter is factored into the ranking. Similar to the fourth iteration, some hotels may have scores for one or more of the previous parameters and will be re-ranked depending on whether or not any of the hotels from the previous batch also have a value for the fifth parameter. Those hotels that only have a value for the fifth parameter will rank lowest in the overall list rank. The results of the fifth weightage operation is Batch 5.

As before, there already are other hotels in the pool from the first, second and third calibration, that is Batch R3. If their SI score is equal to or less than 2, the system deducts 5% points from those Batch R3 hotels. This is the fourth calibration operation.

Now the system combines these adjusted Batch R3 results and Batch 5, and combines them to become Batch R4.

Batch R4 thus has been through five weightage operations and four calibration operations. Hotels in the pool now have a numerical value based on the five weightage and four calibration operations. The contents of the pool, that is Batch R4, may be displayed in the final ranked results to the user. The final ranked results show hotels listed in an order that reflects the importance of different parameters as an aggregate value tailored to a user's specified input. Thus, for example, if two users searching for hotels in the same city list the same first parameter as most important, their respective lists and order of hotels presented will look different based on the individual multiple parameters each user has entered into the initial search criteria.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media may be utilized. In the context of this disclosure, a computer readable storage medium may be any tangible or non-transitory medium that can contain, or store a program (for example, the program product) for use by or in connection with an instruction execution system, apparatus, or device.

The computer readable media may be performed by a computing device. For example, the host server and the client-side device may be computing devices performing any of the features or processes described above. A computing device may be for example, a computer server, smart mobile telephone devices, personal computer systems, tablet devices, server computer systems, handheld or laptop devices, multiprocessor systems, microprocessor-based systems, set top boxes, programmable consumer electronics, network PCs, and distributed cloud computing environments that include any of the above systems or devices, and the like. The computing device may be described in the general context of computer system executable instructions, such as program modules, being executed by a computer system. In some embodiments, the computing device may be a cloud computing node connected to a cloud computing network. The computing device may be practiced in distributed cloud computing environments where tasks are performed by remote processing devices that are linked through a communications network. In a distributed cloud computing environment, program modules may be located in both local and remote computer system storage media including memory storage devices.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. For example, while the illustrative embodiment has presented a process using five parameters and five iterations of ranking based on those five parameters, it should be understood that this is for illustrative purposes only. Some embodiments may use as little as three parameters and other embodiments may use more than five parameters. Thus, given the wide variety of configurations and arrangements of embodiments of the present invention the scope of the invention is reflected by the breadth of the claims below rather than narrowed by the embodiments described above.

I claim:

1. A computer implemented method for generating hotel ratings of queried hotels' availability, comprising:
receiving a user query for hotels in a user specified area;
receiving two or more user specified hotel parameters;
receiving a user specified ranking of importance for each user specified hotel parameter;
retrieving from a database, a first list of hotels based on a first user specified parameter, wherein the first user specified parameter is of a highest ranked importance;
attaching a highest weighting value to each of hotels in the first list of hotels;
retrieving from the database, a second list of hotels based on a second user specified parameter, wherein the second user specified parameter is of a second highest ranked importance;
attaching a second highest weighting value to each of hotels in the second list of hotels;
initially ranking the hotels in the first list and in the second list based on the highest weighting value and the second highest weighting value;
identifying hotels in the first list of hotels that have a rating score below a threshold value for the second user specified parameter;
deducting a first point value from the hotels in the first list of hotels that have the rating score below the threshold value for the second user specified parameter;
adding second point values associated with the second parameter, for all eligible hotels in the database with a second parameter value above 0;
adjusting the ranking for the hotels in the first list of hotels that have a rating score below the threshold value for the second user specified parameter based on the deducted first point value and added second point values associated with the second parameter; and
ranking hotels in the first and second lists based on the first user specified parameter and the second user specified parameter, wherein a list of the ranking is displayed to the user to include the adjustment for hotels in the first list with deducted first point values and the added second point values.

2. The computer implemented method of claim 1, further comprising:
retrieving from the database, a third list of hotels based on a third user specified parameter, wherein the third user specified parameter is of a third highest ranked importance;
attaching a third highest weighting value to each of hotels in the third list of hotels;
identifying hotels in the first and second lists of hotels that have a rating score below a threshold value for the third user specified parameter;
deducting a third point value from the hotels in the first and second lists of hotels that have a rating score below the threshold value for the third user specified parameter;
adding fourth point values associated with the third parameter, for all eligible hotels in the database with a third parameter value above 0;
adjusting the ranking for the hotels in the first and second lists of hotels that have a rating score below the threshold value for the third user specified parameter based on the deducted third point value and the added fourth point value.

3. The computer implemented method of claim 2, wherein the third point value is lower than the first point value.

4. The computer implemented method of claim 2, further comprising ranking hotels in the first, second, and third lists based on the first user specified parameter, the second user specified parameter, and the third user specified parameter.

5. The computer implemented method of claim 1, wherein the user specified parameters include two or more of an availability of one or more amenities, a distance to an attraction, a room price, and an on-site restaurant quality.

6. A computer program product for generating hotel ratings of queried hotels' availability, the computer program product comprising:
one or more computer readable storage media, and program instructions collectively stored on the one or more computer readable storage media, the program instructions comprising:
receiving a user query for hotels in a user specified area;
receiving two or more user specified hotel parameters;
receiving a user specified ranking of importance for each user specified hotel parameter;
retrieving from a database, a first list of hotels based on a first user specified parameter, wherein the first user specified parameter is of a highest ranked importance;
attaching a highest weighting value to each of hotels in the first list of hotels;
retrieving from the database, a second list of hotels based on a second user specified parameter, wherein the second user specified parameter is of a second highest ranked importance;
attaching a second highest weighting value to each of hotels in the second list of hotels;
initially ranking the hotels in the first list and in the second list based on the highest weighting value and the second highest weighting value;
identifying hotels in the first list of hotels that have a rating score below a threshold value for the second user specified parameter;
deducting a first point value from the hotels in the first list of hotels that have the rating score below the threshold value for the second user specified parameter;
adding second point values associated with the second parameter, for all eligible hotels in the database with a second parameter value above 0;
adjusting the ranking for the hotels in the first list of hotels that have a rating score below the threshold value for the second user specified parameter based on the deducted first point value and added second point values associated with the second parameter; and
ranking hotels in the first and second lists based on the first user specified parameter and the second user specified parameter, wherein a list of the ranking is displayed to the user to include the adjustment for hotels in the first list with deducted first point values and the added second point values.

7. The computer program product of claim 6, wherein the program instructions further comprise:
retrieving from the database, a third list of hotels based on a third user specified parameter, wherein the third user specified parameter is of a third highest ranked importance;
attaching a third highest weighting value to each of hotels in the third list of hotels;
identifying hotels in the first and second lists of hotels that have a rating score below a threshold value for the third user specified parameter;
deducting a third point value from the hotels in the first and second lists of hotels that have a rating score below the threshold value for the third user specified parameter;
adding fourth point values associated with the third parameter, for all eligible hotels in the database with a third parameter value above 0;
adjusting the ranking for the hotels in the first and second lists of hotels that have a rating score below the threshold value for the third user specified parameter based on the deducted third point value and the added fourth point value.

8. The computer program product of claim 7, wherein the third point value is lower than the first point value.

9. The computer program product of claim 7, wherein the program instructions further comprise ranking hotels in the first, second, and third lists based on the first user specified parameter, the second user specified parameter, and the third user specified parameter.

10. The computer program product of claim 6, wherein the user specified parameters include two or more of an availability of one or more amenities, a distance to an attraction, a room price, and an on-site restaurant quality.

11. A computer server for generating hotel ratings of queried hotels' availability, comprising:
a network connection;
one or more computer readable storage media;
a processor coupled to the network connection and coupled to the one or more computer readable storage media; and
a computer program product comprising program instructions collectively stored on the one or more computer readable storage media, the program instructions comprising:
receiving a user query for hotels in a user specified area;
receiving two or more user specified hotel parameters;
receiving a user specified ranking of importance for each user specified hotel parameter;
retrieving from a database, a first list of hotels based on a first user specified parameter, wherein the first user specified parameter is of a highest ranked importance;
attaching a highest weighting value to each of hotels in the first list of hotels;
retrieving from the database, a second list of hotels based on a second user specified parameter, wherein the second user specified parameter is of a second highest ranked importance;
attaching a second highest weighting value to each of hotels in the second list of hotels;
initially ranking the hotels in the first list and in the second list based on the highest weighting value and the second highest weighting value;
identifying hotels in the first list of hotels that have a rating score below a threshold value for the second user specified parameter;
deducting a first point value from the hotels in the first list of hotels that have the rating score below the threshold value for the second user specified parameter;
adding second point values associated with the second parameter, for all eligible hotels in the database with a second parameter value above 0;
adjusting the ranking for the hotels in the first list of hotels that have a rating score below the threshold value for the second user specified parameter based on the deducted first point value and added second point values associated with the second parameter; and
ranking hotels in the first and second lists based on the first user specified parameter and the second user specified parameter, wherein a list of the ranking is displayed to the user to include the adjustment for hotels in the first list with deducted first point values and the added second point values.

12. The computer server of claim 11, wherein the program instructions further comprise:
retrieving from the database, a third list of hotels based on a third user specified parameter, wherein the third user specified parameter is of a third highest ranked importance;
attaching a third highest weighting value to each of hotels in the third list of hotels;
identifying hotels in the first and second lists of hotels that have a rating score below a threshold value for the third user specified parameter;
deducting a third point value from the hotels in the first and second lists of hotels that have a rating score below the threshold value for the third user specified parameter;
adding fourth point values associated with the third parameter, for all eligible hotels in the database with a third parameter value above 0;
adjusting the ranking for the hotels in the first and second lists of hotels that have a rating score below the threshold value for the third user specified parameter based on the deducted third point value and the added fourth point value.

13. The computer server of claim 12, wherein the third point value is lower than the first point value.

14. The computer server of claim 12, wherein the program instructions further comprise ranking hotels in the first, second, and third lists based on the first user specified parameter, the second user specified parameter, and the third user specified parameter.

15. The computer server of claim 11, wherein the user specified parameters include two or more of an availability of one or more amenities, a distance to an attraction, a room price, and an on-site restaurant quality.
